(19) United States
(12) Patent Application Publication
(10) Pub. No.: US 2026/0064396 A1
(43) Pub. Date: Mar. 5, 2026

(54) MULTI-SYSTEM AI REPOSITORY CONTROLLER

(71) Applicant: HEWLETT PACKARD ENTERPRISE DEVELOPMENT LP, Spring, TX (US)

(72) Inventors: PRAKASH MIRJI, Spring, TX (US); Swami Viswanathan, Morgan Hill, CA (US); Krishan Sagiraju, Andover, MA (US)

(21) Appl. No.: 18/822,824

(22) Filed: Sep. 3, 2024

(51) Int. Cl. G06F 8/61

(52) U.S. Cl. CPC G06F 8/61

(57) ABSTRACT

Systems and methods are provided for creating a machine learning (ML) model staging repository, where ML models are stored as an open container image (OCI). The OCI comprises layers or portions of the complete ML model, so that the model can be stored separately and as a smaller files. The ML models may be pre-packaged for automated downloads and integration at the customer site. In some examples, the OCI can identify/store the model in a directory structure that defines the model and its profile. The OCI can comprise a combination of layers and profiles that allows the AI platform to optimize the storage and simplify the process of downloading or updating the given user namespace instead of downloading a single large file for the model.

### CROSS-REFERENCE TO RELATED APPLICATIONS

This application is co-pending with U.S. patent application Ser. No. ______ (Docket: P175597US (109793-01455)) and U.S. patent application Ser. No. ______ (Docket: P175628IN (109793-01456)), the contents of which are incorporated by reference in their entirety for all purposes.

### BACKGROUND

Machine learning models are processes the enable computers to learn from data and make decisions or predictions without being explicitly programmed for specific tasks. These models improve their performance as they are exposed to more data over time.

Types of machine learning models can include supervised learning models, like linear regression and classification models, unsupervised learning models, like clustering and dimensionality reduction, reinforcement learning models, and semi-supervised and self-supervised learning models. One type of machine learning model is a Large Language Models (LLMs) that involves both unsupervised and self-supervised learning. In LLMs, the models are specifically designed to understand, generate, and manipulate human language through advanced neural network architectures and programmatic executions to analyze large collections of data.

Since these LLMs are so complex, customer environments often run these models remotely from a model provider or other remote system. However, the use of remote systems can introduce security concerns with transferring data over an open network, restricting access to users who are permitted to access sensitive data, or issues with sharing a remote system with other entities, who are possibly direct competitors with the customer.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration that may be implemented for an organization, such as a business, educational institution, governmental entity, healthcare facility or other organization.

FIG. 2 is an illustrative AI platform with a user namespace and a set of repositories, in some examples of the disclosure.

FIG. 3 is an illustrative AI platform with a user namespace and a set of repositories, in some examples of the disclosure.

FIG. 4 illustrates a process for downloading and updating an open container image (OCI), in some examples of the disclosure.

FIG. 5 illustrates an open container image (OCI), in some examples of the disclosure.

FIG. 6 is an illustrative interface provided by the AI platform, in some examples of the disclosure.

FIG. 7 is an example computing component that may be used to implement various features of a set of models in accordance with examples discussed herein.

FIG. 8 is a computing component that may be used to implement examples of the disclosed technology.

The figures are not exhaustive and do not limit the present disclosure to the precise form disclosed.

### DETAILED DESCRIPTION

Traditional LLMs are massive (e.g., 50-100 GB models) and downloading may take days to download in a customer computing environment, due to technical limitations of the network. For example, the customer site may implement an intranet, private cloud, or other private network that is only accessible to authenticated and authorized members of the customer site, while other entities may utilize an Internet or other public network to attempt to communicate with devices at the customer site. This limits the ability for customer sites to utilize machine learning models in private, secured networks.

Examples of the disclosed AI platform create a machine learning (ML) model staging repository, where ML models are stored as an open container image (OCI). The OCI comprises layers or portions of the complete ML model, so that the model can be stored separately and as a smaller files. The ML models may be pre-packaged for automated downloads and integration at the customer site. In some examples, the OCI can identify/store the model in a directory structure that defines the model and its profile. The OCI can comprise a combination of layers and profiles that allows the AI platform to optimize the storage and simplify the process of downloading or updating the given user namespace instead of downloading a single large file for the model.

Once the AI platform has generated the OCI, the AI platform can provide the OCI to the model staging repository (e.g., global repository) that synchronizes the OCI with a public marketplace of OCIs. A local repository associated with the customer environment may identify an updated OCI on the public marketplace and initiate an automatic download for the OCI (or a portion/layer of the OCI). From the local repository, the AI platform may automatically extract the OCI into a model volume while maintaining the same directory structure. In some examples, the model volume may be mounted into an inference service to read the model from local cache instead of downloading the model to the customer computing environment during runtime.

The extraction process may store the model to a local cache that clones the model/layer to a user namespace. The user namespace may expose the downloaded model to the user operating a client device to utilize the model. In some examples, the model may be exposed to the user via an interface displayed by the client device that allows the user to select and deploy the model when the user has proper authorization to deploy/execute the model.

In response to an update to the model/layer, the AI platform may initiate a synchronization process that automatically updates the local repository, the cache, and the user namespace. The synchronization process can push any updates to deployed models or other components of the customer computing environment.

Technical improvements are illustrated throughout the disclosure. For example, the use of OCI can comprise a combination of layers and profiles that allows the AI platform to optimize the storage and simplify the process of downloading or updating the given user namespace instead of downloading a single large file for the model. This can create more efficient processing to allow for larger portions of the bandwidth to be reserved for other components of the system.

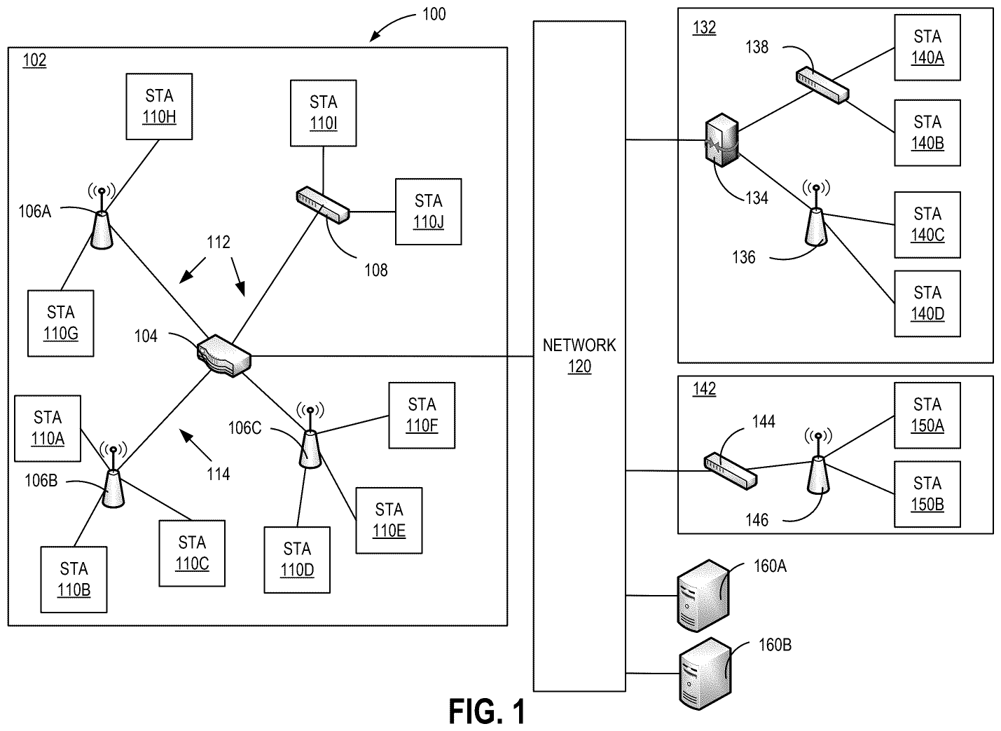

Before describing various examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices 110) and possibly multiple physical or geographical sites 102, 132, 142. Network configuration 100 may include primary site 102 in communication with network 120 that stores the AI platform. Network configuration 100 may also include one or more remote sites 132, 142, each of which may store portions/components of the AI platform. In some examples, primary site 102 and remote sites 132, 142 may also store various registries/repositories and the OCI marketplace.

Primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, primary site 102 includes controller 104, which is in communication with network 120. Controller 104 may provide communication with network 120 for primary site 102. There may be other points of communication with network 120 for primary site 102 in addition to controller 104. Although single device associated with controller 104 is illustrated, primary site 102 may include multiple controllers and/or multiple communication points with network 120. In some examples, controller 104 may communicate with network 120 through a router. In other examples, controller 104 provides router functionality to the devices in primary site 102. In this specification, the word “tunnel” refers to an encapsulated mode of transporting data between AP and controller.

Controller 104 may be operable to configure and manage network devices, such as at primary site 102, and may also manage network devices at remote sites 132, 142. Controller 104 may be operable to configure and/or manage switches, routers, access points, and/or client devices connected to a network. Controller 104 may itself be, or provide the functionality of, an Access Point (AP).

Controller 104 may be in communication with one or more switches 108 and/or wireless Access Points (APs) 106a-c. Switches 108 and wireless APs 106a-c provide network connectivity to various client devices 110a-j. Using a connection to switch 108 or AP 106a-c, client device 110a-j may access network resources, including other devices on the (primary site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within primary site 102, switch 108 is included as one example of a point of access to the network established in primary site 102 for wired client devices 110i-j. Client devices 110i-j may connect to switch 108 and through switch 108, may be able to access other devices within network configuration 100. Client devices 110i-j may also be able to access network 120, through switch 108. Client devices 110i-j may communicate with switch 108 over a wired or wireless connection 112. In the illustrated example, switch 108 communicates with controller 104 over a wired or wireless connection 112.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the example of FIG. 1, APs 106a-c can be managed and configured by controller 104. APs 106a-c communicate with controller 104 and the network over connections 112, which may be either wired or wireless interfaces.

Network configuration 100 may include one or more remote sites 132. Remote site 132 may be located in a different physical or geographical location from primary site 102. In some cases, remote site 132 may be in the same geographical location, or possibly the same building, as primary site 102, but lacks a direct connection to the network located within primary site 102. Instead, remote site 132 may utilize a connection over a different network, e.g., network 120. Remote site 132 such as the one illustrated in FIG. 1 may be a satellite office, another floor or suite in a building, for example. Remote site 132 may include gateway device 134 for communicating with network 120. Gateway device 134 may be a router, a digital-to-analog modem, a cable modem, a digital subscriber line (DSL) modem, or some other network device configured to communicate with network 120. Remote site 132 may also include switch 138 and/or AP 136 in communication with gateway device 134 over either wired or wireless connections. Switch 138 and AP 136 provide connectivity to the network for various client devices 140a-d.

In various examples, remote site 132 may be in direct communication with primary site 102, such that client devices 140a-d at remote site 132 access the network resources at primary site 102 as if these client devices 140a-d were located at primary site 102. In such examples, remote site 132 is managed by controller 104 at primary site 102, and controller 104 provides the necessary connectivity, security, and accessibility that enable the connection between remote site 132 and primary site 102. Once connected to primary site 102, remote site 132 may function as a part of a private network provided by primary site 102.

In various examples, network configuration 100 may include one or more smaller remote sites 142, comprising gateway device 144 for communicating with network 120 and wireless AP 146, by which various client devices 150a-b access network 120. Examples of remote site 142 may represent, for example, an individual employee's home or a temporary remote office. Remote site 142 may also be in communication with primary site 102, such that client devices 150a-b at remote site 142 access network resources at primary site 102 as if these client devices 150a-b were located at primary site 102. Remote site 142 may be managed by controller 104 at primary site 102 to make this transparency possible. Once connected to primary site 102, remote site 142 may function as a part of a private network provided by primary site 102.

Network 120 may be a public or private network, such as the Internet, or other communication network to allow connectivity among various sites 102, 132, 142 as well as access to servers 160a-b. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100 but that facilitate communication between the various parts of the network configuration 100, and between the network configuration 100 and other network-connected entities. Network 120 may include various servers 160a-b. In an example, servers 160a-b may comprise content servers that include various providers of multimedia downloadable and/or streaming content, including audio, video, graphical, and/or text content, or any combination thereof. Examples of content servers 160a-b include web servers, streaming radio and video providers, and cable and satellite television providers. Client devices 110a-j, 140a-d, 150a-b may request and access the multimedia content provided by content servers 160a-b.

In another example, servers 160a-b may comprise flow optimization service server that include various information for provisioning services to client devices 110a-j, 140a-d, 150a-b and optimizing traffic flows in accordance with the examples disclosed herein. Access points 106a-c, 136, and 146; switches 108; and gateway devices 134 and 144 may request or upload information, such as telemetry data, for optimizing rendering of services to client devices 110a-j, 140a-d, 150a-b. The information may include, but is not limited to, a measure or estimate of QoE on a per traffic flow basis (e.g., referred to herein as a QoE score); flow characteristics and other QoS measurements, such as but not limited to, jitter, delay, airtime, latency, etc.; analytics; transmission protocols (e.g., OFDMA and MU-MIMO), and the like. The information may be stored in a database, which can be communicatively coupled to servers 160a, 160b. In examples, servers 160a-b may be cloud-based, which would be understood by those of ordinary skill in the art to refer to being, e.g., remotely hosted on a system/servers in a network (rather than being hosted on local servers/computers) and remotely accessible.

In examples where servers 160a-b are cloud-based, servers 160a-b may store components of a public cloud and a private cloud, respectively. The private cloud may implement an integrated AI platform at the customer site to deploy ML models from a model repository. In some examples, the server that implements the public cloud may store machine learning models that can be downloaded to the private cloud and integrated into the private cloud.

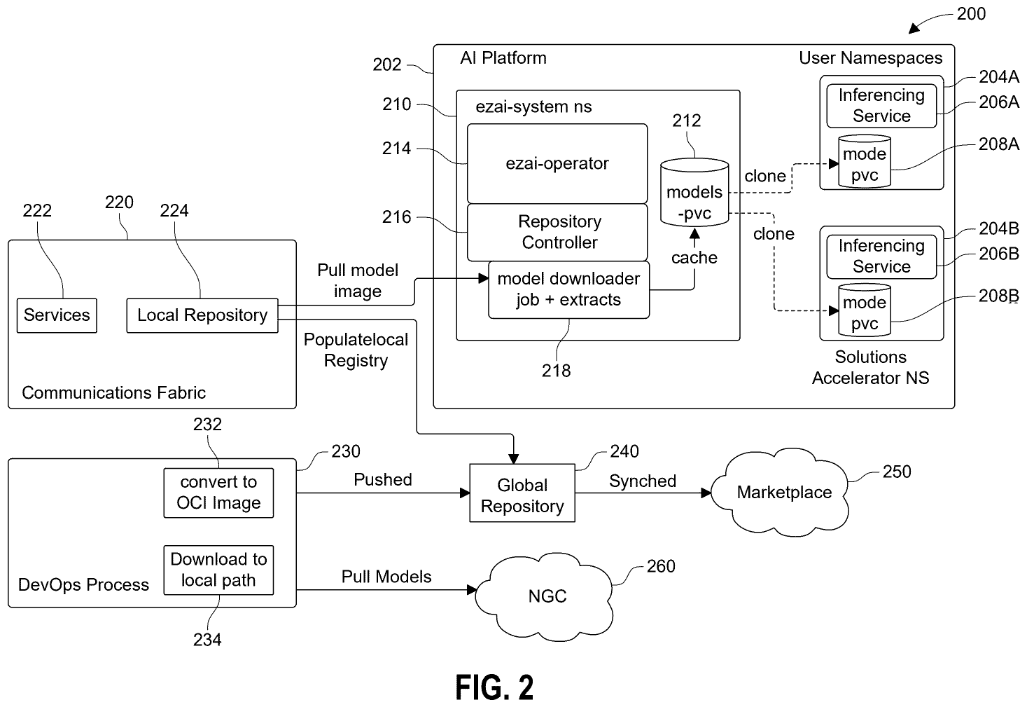

FIG. 2 is an illustrative AI platform with a user namespace and a set of repositories, in some examples of the disclosure. In example 200, AI platform 202, communication fabric 220, dev ops process 230, repository 240, marketplace 250, and NGC 260 are shown.

AI platform 202 (e.g., AI Essentials™) is configured to synchronize and update layers of the OCI and/or models throughout the platform and to external devices. In some examples, the OCI is stored as Docker container layers. The layers may be split or separated, such that when one layer is changed/updated, the entire image does not need to be changed/updated. In this case, any updated layers may be stored or transmitted separately from the other layers of the OCI. In these examples, the layers or portions of the OCI correspond with portions of a complete ML model, so that the model can be stored separately and as a smaller files.

AI platform 202 comprises user namespaces 204 (illustrated as first user namespace 204A and second user namespace 204B) and AI system 210. User namespaces 204 are configured to divide cluster resources (e.g., within the Kubernetes™ platform) between multiple users or applications. In some examples, user namespaces 204 may act as a virtual cluster within a Kubernetes™ cluster or AI platform 202 overall. In some examples, user namespaces 204 may isolate resources in a first user namespace from resources in other user namespaces (e.g., namespace-specific resources are separated from one another). This separation may help AI platform 202 manage resource quotas and limits and reduce the risk of naming conflicts. In some examples, user namespaces 204 may help implement different access controls and policies for different parts of the cluster. The access controls may implement Role-Based Access Control (RBAC) or token-based access control to grant permissions specific to a namespace.

User namespace 204 may comprise an inferencing service 206 (illustrated as first inferencing service 206A and second inferencing service 206B) and model repository 208 (illustrated as first model repository 208A and second model repository 208B). Inferencing service 206 is configured to automatically determine the appropriate namespaces for deploying resources based on parameters, such as the type of application or its environment (e.g., development, staging, production).

Model repository 208 may correspond with a persistent data store that limits access to data for the particular namespace. Each model repository 208 may restrict access to the data from other namespaces.

AI system 210 (e.g., EZAI-systems™) is configured to define a control plane of AI platform 202 that monitors, deploys, and updates services using local cache 212, AI operator 214, AI repository/registry controller 216, and model downloader process 218. For example, local cache 212 may comprise data that has been copied from local repository 224 at communication fabric 220. Once the data is stored in local cache 212, AI platform 202 is configured to clone the data to the appropriate user namespace 204 (e.g., based on policies or other determinations).

AI operator 214 is configured to deploy and manage an application by using custom controllers and resources. In some examples, AI operator 214 deploys AI repository/registry controller 216 to manage the lifecycle of the application based on the state defined in the Custom Resource Definitions (CRDs). The controllers can perform complex tasks such as application scaling, backups, and updates.

Model downloader process 218 is configured to automatically download the OCI from local repository 224. Model downloader process 218 is also configured to extract the machine learning model to local cache 212 from local repository 224 (e.g., the layers of the OCI).

AI system 210 is also configured to clone the layer of the OCI from local cache 212 to a user namespace 204, where the machine learning model can be utilized for inference processes. The model may be mounted to inferencing service 206 to read the model from local cache 212 or model repository 208 (local to the namespace) instead of downloading the model during runtime.

Communication fabric 220 (e.g., EZFab OVA) may correspond with a Virtual Machine (VM) image file format for storing data in a virtualized environment. Communication fabric 220 comprises data that has been pushed/downloaded by dev ops process 230 and stored with local repository 224.

Dev ops process 230 is configured to coordinate downloading and storage of data throughout the network, including data stored with global repository 240 and NGC catalog 260, and providing/pushing data to marketplace 250. In some examples, dev ops process 230 executes a set of processes/jobs, including convert to OCI image process 232 and download to local path process 234.

Convert to OCI image process 232 is configured to generating an open container image (OCI) comprising a set of layers of a machine learning model. For example, process 232 may pull/download the ML model from NGC 260 and provide the OCI to global repository 240.

In some examples, download to local path process 234 identifies source (e.g., NGC catalog 260) and destination (e.g., local repository 224 or repository 240) of the data. In some examples, repository 240 may synchronize the OCI with a public marketplace 250 that comprises multiple open container images (OCIs). In other examples, AI platform 202 may automatically download a layer of the OCI to local repository 224 of a customer computing environment from global repository 240.

Repository 240 is configured to act as a global repository in communication with marketplace 250 and communication fabric 220. Repository 240 may store an OCI that is pushed from dev ops process 230. Repository 240 may also synchronize the OCI with marketplace 250.

Marketplace 250 is configured to store layers of the OCI (e.g., in a container repository). In some examples, marketplace 250 is an online platform that provides access to download and manage data, hardware or software purchases, applications/products, and services.

NGC catalog 260 (e.g., NVIDIA GPU Cloud (NGC) Catalog) is configured as a repository of pre-built software containers and other resources that helps simply the deployment of applications and workflows. For example, NGC Catalog 260 may comprise Docker containers that include machine learning models, such as TensorFlow, PyTorch, and MXNet. In some examples, the containers are pre-configured with various protocols (e.g., NVIDIA's CUDA and cuDNN libraries) to help expedite communications with the containers.

In some examples, NGC catalog 260 comprises development tools and libraries that facilitate development and deployment of GPU-accelerated applications. As illustrative examples, the tools and libraries may include NVIDIA's RAPIDS data science libraries, NVIDIA Data Loading Library (DALI), and other utilities designed to enhance performance and ease of use.

In some examples, NGC catalog 260 implements version control of containers and models. The version control may help users to access and deploy specific versions of applications, data, and so on.

In an illustrative example, the system illustrated in FIG. 2 may be implemented for staging ML models. Staging the models by AI platform 202 may involve two phases. The first phase may comprise downloading the ML models from NGC catalog 260. These may be converted to OCI images by process 232 and pushed to repository 240. When product package is created, it identifies repository 240. The second phase may include AI operator 214 deploying and managing the OCI. To store and render the models, the model may be pulled from local repository 224 and extracting the model to local cache 212.

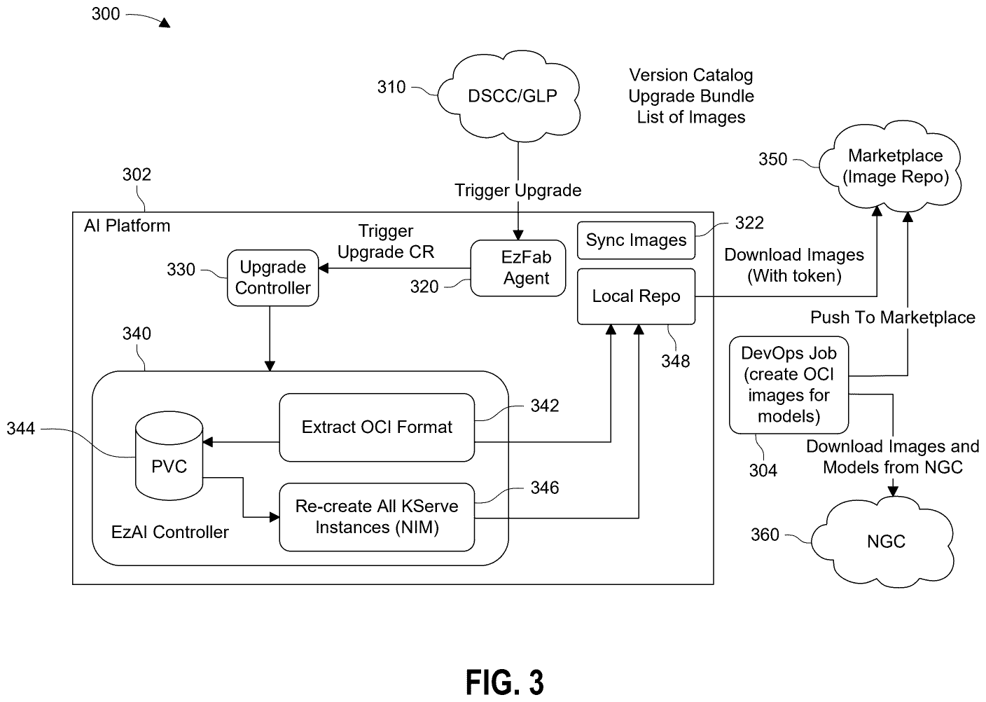

FIG. 3 is an illustrative AI platform with a user namespace and a set of repositories, in some examples of the disclosure. In example 300, AI platform 302, dev ops process 304, DSCC/GLP 310, communication fabric agent 320, upgrade controller 330, AI controller 340, local repository 348, marketplace 350, and NGC 360 are shown. AI platform 302, dev ops process 304, local repository 348, marketplace 350, and NGC catalog 360 illustrated in FIG. 3 may correspond with AI platform 202, dev ops process 230, local repository 224, marketplace 250, and NGC catalog 260 illustrated in FIG. 2, respectively.

Dev ops process 304 is configured to monitor NGC catalog 360 for updates and coordinate downloading and storage of data throughout the network once the data is downloaded. In some examples, dev ops process 304 generates an OCI with the data that is downloaded from NGC catalog 360. Dev ops process 304 is also configured to provide the OCI to marketplace 350 or a corresponding image repository that is accessible by AI platform 302. Once the OCI is uploaded/pushed to marketplace 350, the local repository 348 of AI platform may receive the OCI from marketplace 350.

AI platform 302 comprises communication fabric agent 320, upgrade controller 330, AI controller 340, and local repository 348. Communication fabric agent 320 is configured to receive a trigger update from DSCC/GLP 310 and synchronize the layer(s) of OCI 322 with various repositories, including local repository 348. In some examples, DSCC/GLP 310 is configured as a data repository that is monitored by communication fabric agent 320 for updates.

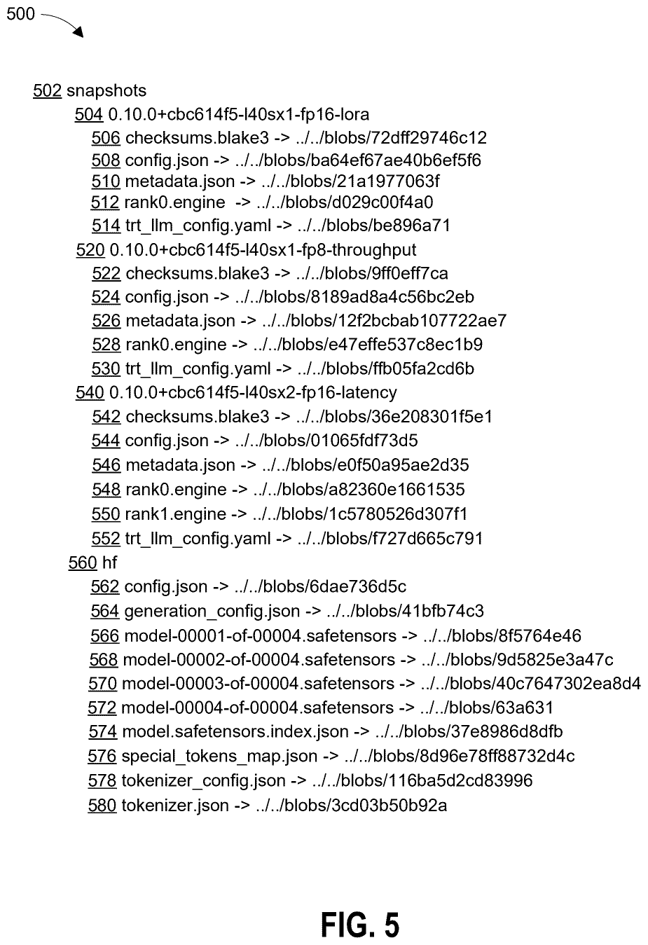

In some examples, communication fabric agent 320 may also trigger upgrade controller 330 of AI platform 302 to identify that the data has changed. In this example, communication fabric agent 320 is configured to implement a version control process of the layers of the OCI. When upgrade controller 330 is triggered, a download process may be initiated to access the local repository and convert the new files into the OCI directory structure (further illustrated in FIG. 5). The inferencing service of the user namespace may read the updated files from local cache that was populated by the controller.

AI controller 340 is configured to operate as a control loop that monitors the state of the clusters in AI platform 302 and requests changes to the clusters. For example, when the current state deviates from the desired state, AI controller 340 can take actions to reconcile the difference. As an illustrative example, if a Deployment specifies three replicas but only two are running, the Deployment controller can generate an additional Pod to match the desired state.

AI controller 340 comprises a set of processes/jobs, including extract OCI format 342, data store 344, and recreate instances 346. Extract OCI format 342 is configured to automatically download the OCI from local repository 348. Extract OCI format 342 is also configured to extract the machine learning model to data store 344 (e.g., as a local cache) and recreate any instances of the NIM, including the serving container image and the model.

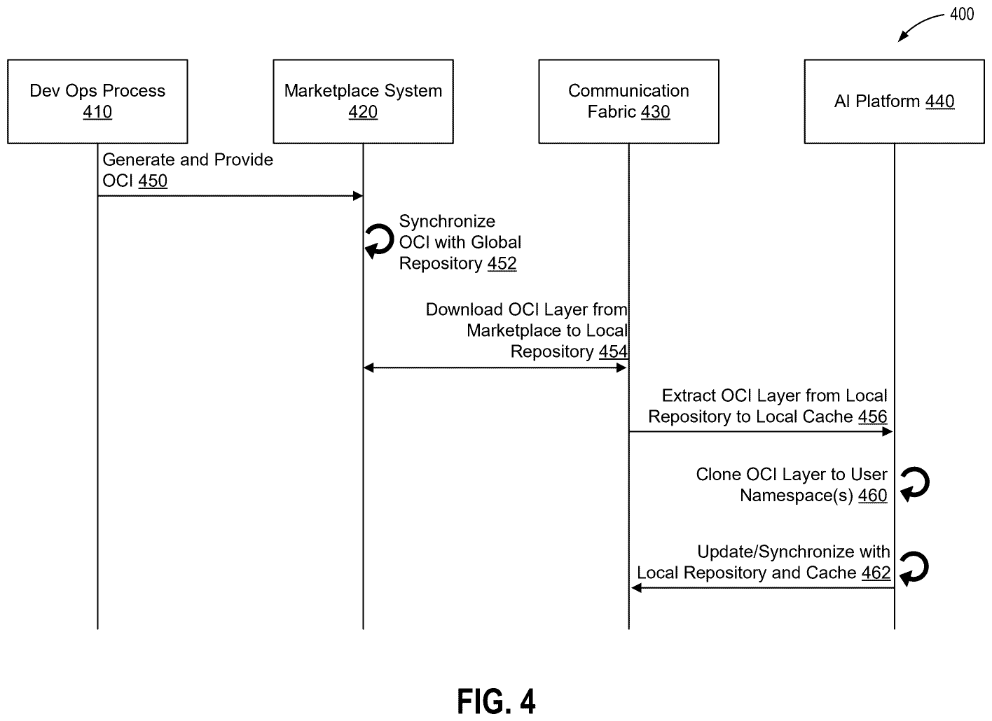

FIG. 4 illustrates a process for downloading and updating an open container image (OCI), in some examples of the disclosure. In example 400, dev ops process 410, marketplace system 420, communication fabric 430, and AI platform 440 are shown. Dev ops process 410, marketplace system 420, communication fabric 430, and AI platform 440 in FIG. 4 may be similar to dev ops process 230, marketplace 250, communication fabric 220, and AI platform 202 in FIG. 2, respectively.

At block 450, dev ops process 410 generates and provides the OCI to marketplace system 420. The OCI comprises layers or portions of the complete ML model, so that the model can be stored separately and as a smaller files.

At block 452, marketplace system 420 synchronizes the OCI with the global repository. For example, once dev ops process 410 has generated the OCI, dev ops process 410 can provide the OCI to the global repository that synchronizes the OCI with marketplace system 420, which stores a set of OCIs from multiple platforms.

At block 454, communication fabric 430 may download at least one layer of the OCI from marketplace system 420 to a local repository. For example, a local repository associated with the customer environment may identify an updated OCI on marketplace system 420 and initiate an automatic download for the OCI (or a portion/layer of the OCI).

At block 456, AI platform 440 extracts a layer from the OCI from the local repository to a local cache. For example, from the local repository, AI platform 440 may automatically extract the OCI into a model volume while maintaining the same directory structure.

At block 460, AI platform 440 clones the layer from the OCI to a user namespace. For example, the extraction process may store the model to a local cache that clones the model/layer to a user namespace. The user namespace may expose the downloaded model to the user operating a client device to utilize the model. In some examples, the model may be exposed to the user via an interface displayed by the client device that allows the user to select and deploy the model when the user has proper authorization to deploy/execute the model.

In some examples, the model volume may be mounted into an inference service of the user namespace to read the model from local cache instead of downloading the model to the customer computing environment during runtime.

In some examples, the downloading/cloning process from the local cache to the user namespace can simplify the process of downloading or updating the given user namespace instead of downloading a single large file for the model.

At block 462, AI platform 440 updates and synchronizes the local cache with the local repository and communication fabric 430. For example, in response to an update to the model/layer, AI platform 440 may initiate a synchronization process that automatically updates the local repository, the cache, and the user namespace. The synchronization process can push any updates to deployed models or other components of the customer computing environment.

In some examples, in response to an update to the layer of the OCI, AI platform 440 may initiate a synchronization process that automatically updates the local repository, the cache, and the user namespace of the customer computing environment.

FIG. 5 illustrates an open container image (OCI), in some examples of the disclosure. In example 500, components of an OCI of a ML model that is stored in a NIM is illustrated. In some examples, the OCI can identify/store the model in a directory structure that defines the model and its profile. The NIM may comprise two parts, including the serving container image and the model, and each model can have one or more profiles.

Example 500 shows four profiles for a snapshot of a model 502. In this example, ML model 502 consists of several profiles (blocks 504, 520, 540, and 560) and each profile consists of several blobs (506, 508, 510, 512, 514, 522, 524, 526, 528, 530, 562, 564, 566, 568, 570, 572, 574, 576, 578, and 580). AI platform may create an OCI image for each profile (blocks 504, 520, 540, and 560) and that image can consist of several layers that corresponds to a blob. This format can allow the system to optimize the storage and simplify the process of downloading or updating the given profile, instead of downloading a large single file for the model.

In some examples, the layers of the model (blocks 566, 568, 570, 572) are separated into smaller files than the overall model. For example, the layers may each correspond with twenty gigabyte files and the size of the entire directory may correspond with an eighty gigabyte file. When an update is implemented at one of the safe tensors in a layer of the model, for example, the single layer may be updated and the remaining layers may remain unchanged.

In some examples, a standard model repository format is identified. The standard model repository may be followed by other repository systems (e.g., hugging face and NGC catalog). The standard model repository may be converted to OCI layers that are stored in a local repository and global repository described herein.

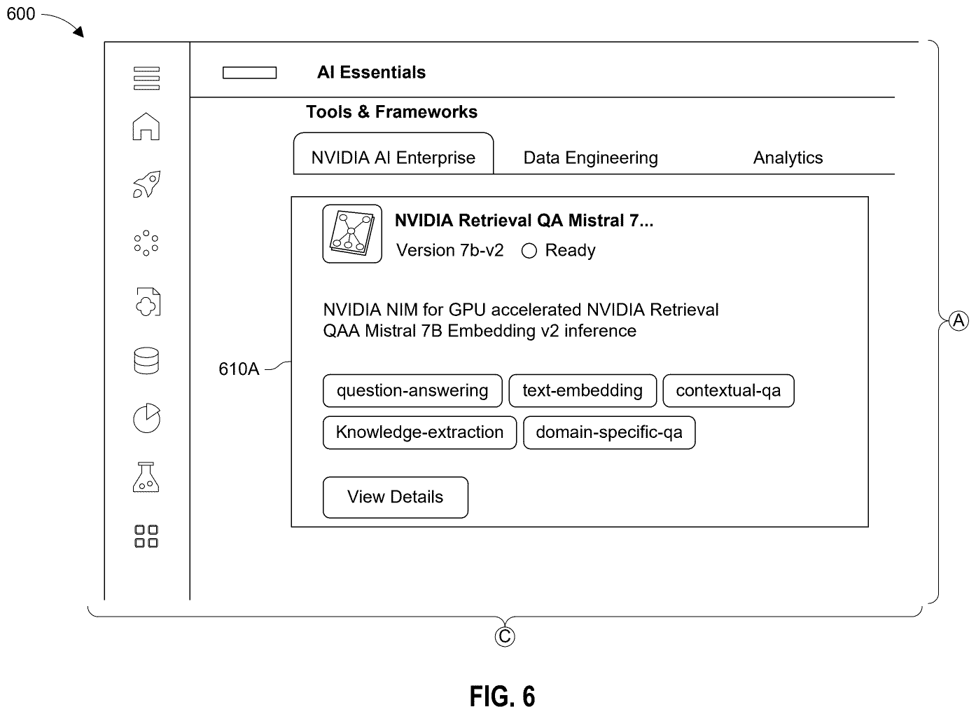

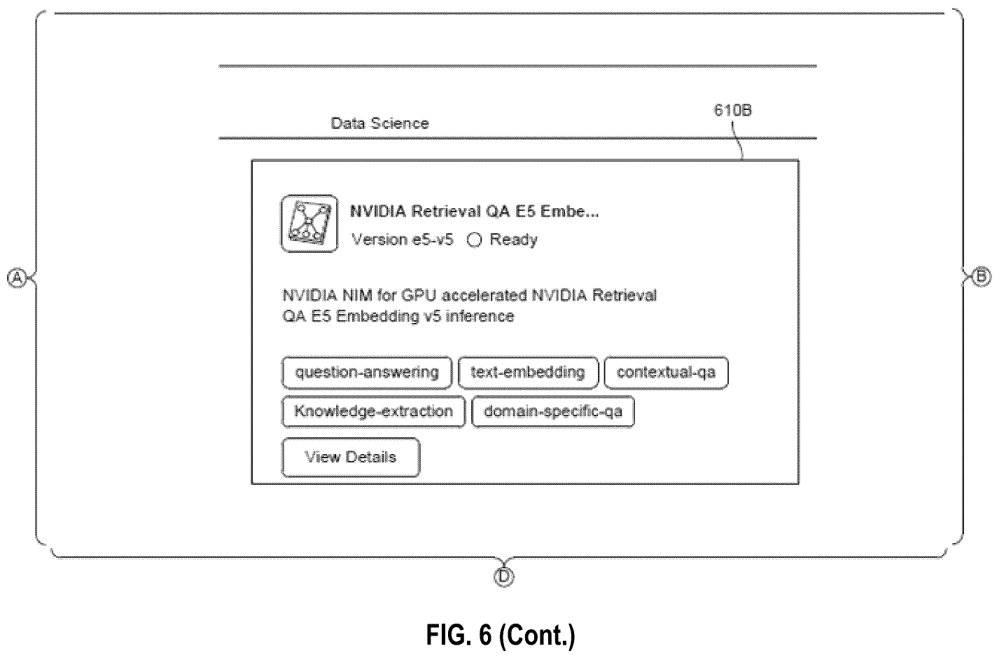

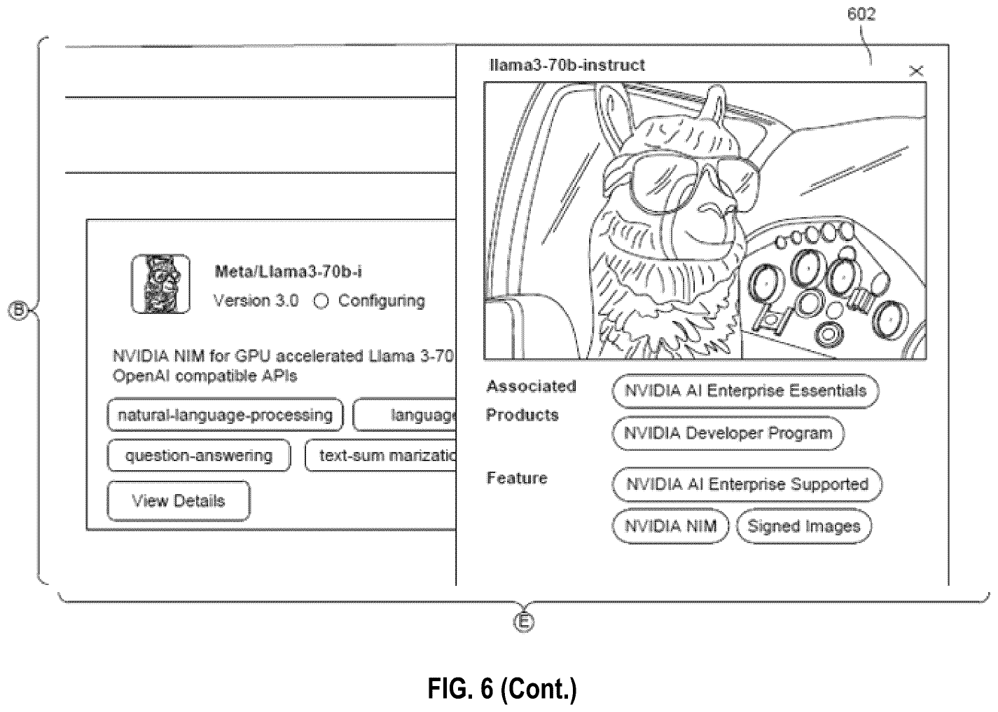

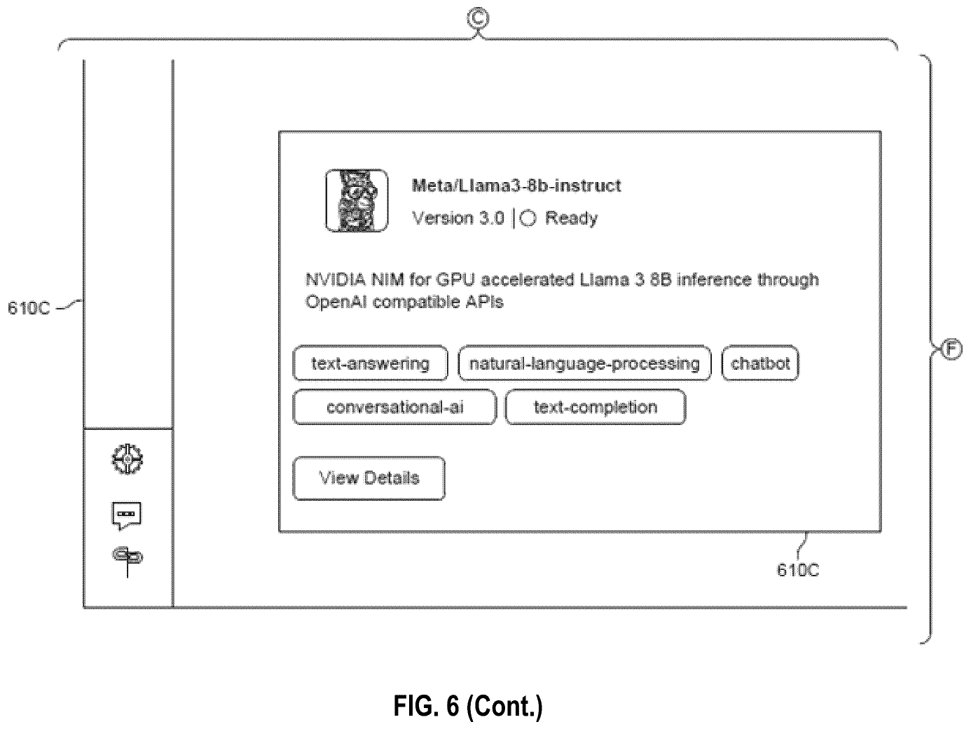

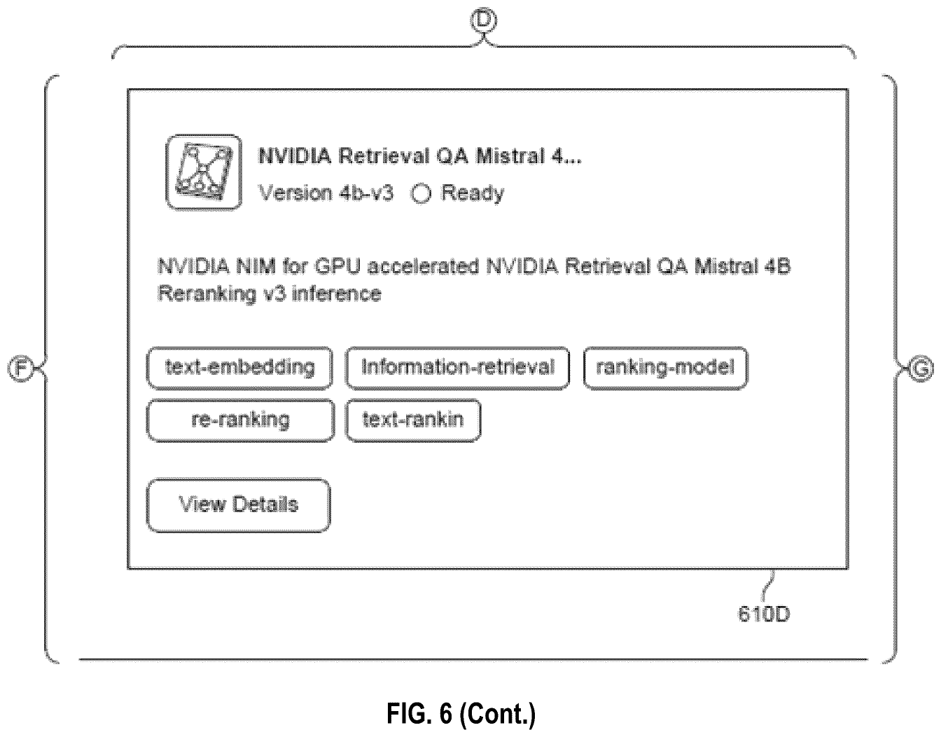

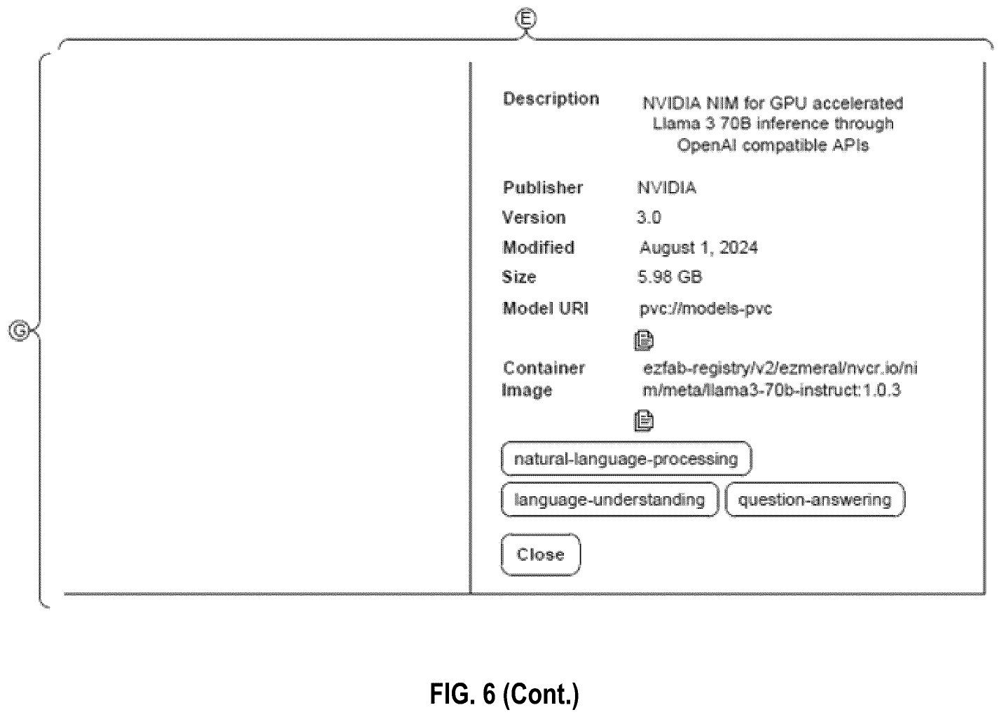

FIG. 6 is an illustrative interface provided by the AI platform, in some examples of the disclosure. In example 600, the interface may illustrate multiple models 610 (illustrated as first model 610A, second model 610B, third model 610C, and fourth model 610D). Each model may be illustrated with a model name to identify an ML model for the user to deploy in the customer environment. When the user selects the model, the interaction may highlight the model at the interface, as shown as highlighted model 602, trigger a download of the ML model to a local cache that is cloned to the user namespace.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

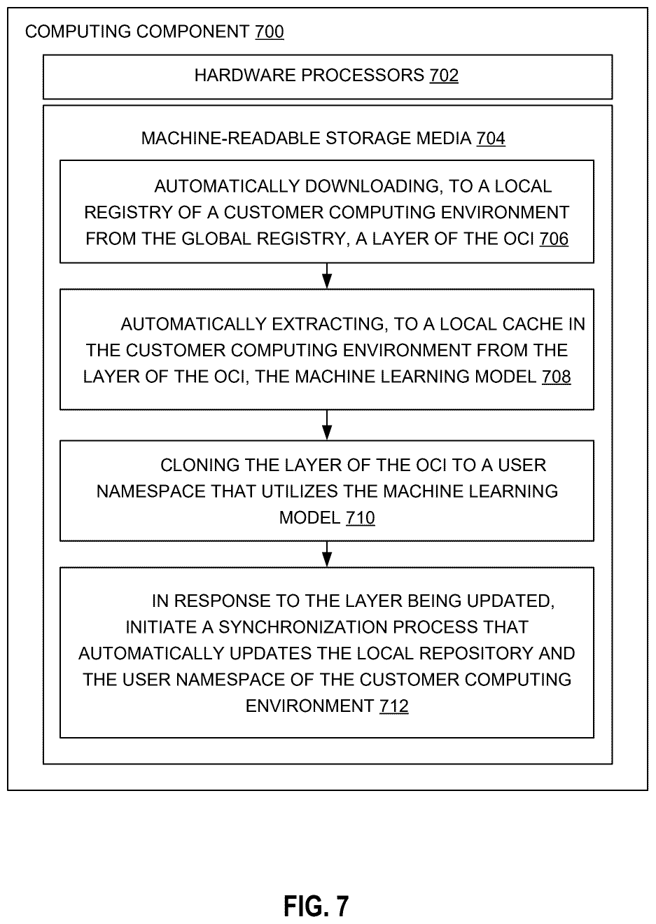

FIG. 7 illustrates a computing component that may be used to implement a lineage-based classification of network events, in accordance with various examples of the disclosed technology. Referring now to FIG. 7, computing component 700 may be, for example, a server computer, a controller, or any other similar computing component capable of processing data. In the example implementation of FIG. 7, the computing component 700 includes hardware processor 702 and machine-readable storage medium 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-712, to control processes or operations for a lineage-based classification of network events. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-712.

Hardware processor 702 may execute instruction 706 to automatically download from a global repository to a local repository of a customer computing environment, a layer of an open container image (OCI). In some examples, the OCI comprises a set of layers of a machine learning model, so that the model can be stored separately and as a smaller files.

In some examples, the ML models may be pre-packaged for automated downloads and integration at the customer site. In some examples, the OCI can identify/store the model in a directory structure that defines the model and its profile. The OCI can comprise a combination of layers and profiles that allows the AI platform to optimize the storage and simplify the process of downloading or updating the given user namespace instead of downloading a single large file for the model.

In some examples, the OCI is generated comprising a set of layers of a machine learning model. The generated OCI may be provided to a global repository that synchronizes the OCI with a public marketplace of OCIs. In some examples, once the AI platform has generated the OCI, the AI platform can provide the OCI to the model staging repository (e.g., global repository) that synchronizes the OCI with the public marketplace of OCIs.

Hardware processor 702 may execute instruction 708 to automatically extract the machine learning model to a local cache in the customer computing environment from the layer of the OCI. In some examples, the local repository associated with the customer environment may identify an updated OCI on the public marketplace and initiate an automatic download for the OCI (or a portion/layer of the OCI). From the local repository, the AI platform may automatically extract the OCI into a model volume while maintaining the same directory structure. In some examples, the model volume may be mounted into an inference service to read the model from local cache instead of downloading the model to the customer computing environment during runtime.

Hardware processor 702 may execute instruction 710 to clone the layer of the OCI from the local cache to a user namespace that utilizes the machine learning model. In some examples, the AI platform may store the model to a local cache that clones the model/layer to a user namespace. The user namespace may expose the downloaded model to the user operating a client device to utilize the model. In some examples, the model may be exposed to the user via an interface displayed by the client device that allows the user to select and deploy the model when the user has proper authorization to deploy/execute the model.

Hardware processor 702 may execute instruction 712 to initiate a synchronization process that automatically updates the local repository and the user namespace of the customer computing environment. In some examples, the synchronization process may be initiated in response to the layer being updated. In some examples, the synchronization process can push any updates to deployed models or other components of the customer computing environment.

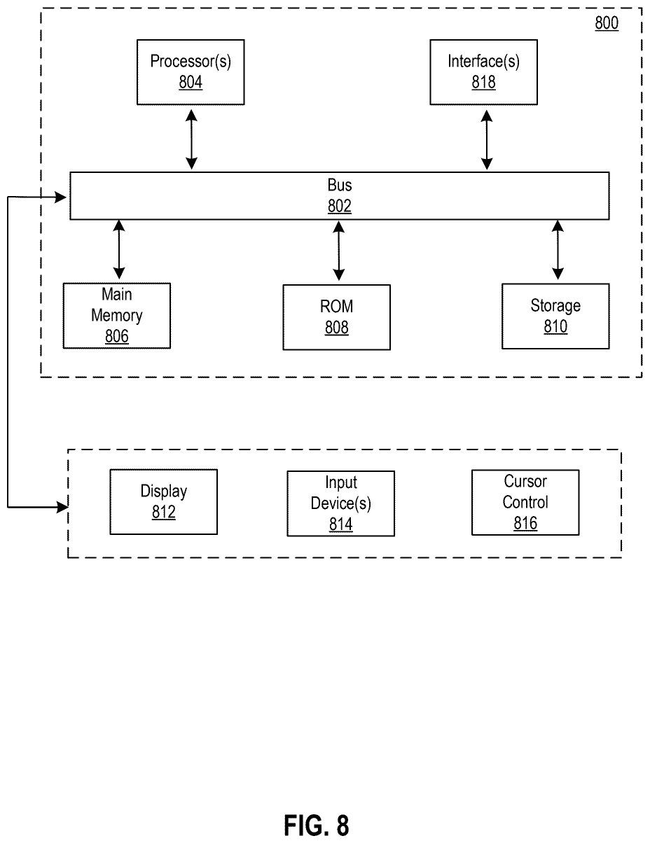

FIG. 8 depicts a block diagram of an example computer system 800 in which various examples of the disclosed technology described herein may be implemented, including the AI platform and other components described herein. Computer system 800 includes bus 802 or other communication mechanism for communicating information, one or more hardware processors 804 coupled with bus 802 for processing information. Hardware processor(s) 804 may be, for example, one or more general purpose microprocessors.

Computer system 800 also includes main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

Computer system 800 further includes read only memory (ROM) 808 or other static storage device coupled to bus 802 for storing static information and instructions for processor 804. Storage device 810, such as a magnetic disk, optical disk, or USB thumb drive (Flash drive), etc., is provided and coupled to bus 802 for storing information and instructions.

Computer system 800 may be coupled via bus 802 to display 812, such as a liquid crystal display (LCD) (or touch screen), for displaying information to a computer user. The display may provide illustrations of selectable models as a type of vending machine of available ML models. The user may interact with the tiles of models. The data displayed may be limited to the data that the user is authorized to access, based on procedures described throughout the disclosure.

Computer system 800 may include a user interface module to implement a GUI to provide to display 812. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data 04tore,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 800 may implement the techniques described herein using customized hard-wired logic, one or more ASICs or FPGAs, firmware and/or program logic which in combination with the computer system causes or programs computer system 800 to be a special-purpose machine. According to one example of the disclosed technology, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

Computer system 800 also includes interface 818 coupled to bus 802. Interface 818 provides a two-way data communication coupling to one or more network links that are connected to one or more local networks. For example, interface 818 may be an integrated services digital network (ISDN) card, cable modem, satellite modem, or a modem to provide a data communication connection to a corresponding type of telephone line. As another example, interface 818 may be a local area network (LAN) card to provide a data communication connection to a compatible LAN (or WAN component to communicate with a WAN). Wireless links may also be implemented. In any such implementation, interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 818, which carry the digital data to and from computer system 800, are example forms of transmission media.

Computer system 800 can send messages and receive data, including program code, through the network(s), network link and interface 818. In the Internet example, a server might transmit a requested code for an application program through the Internet, the ISP, the local network and interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
automatically downloading from a global repository to a local repository of a customer computing environment, a layer of an open container image (OCI), wherein the OCI comprises a set of layers of a machine learning model;
automatically extracting the machine learning model to a local cache in the customer computing environment from the layer of the OCI;
cloning the layer of the OCI from the local cache to a user namespace that utilizes the machine learning model; and
in response to the layer being updated, initiating a synchronization process that automatically updates the local repository and the user namespace of the customer computing environment.

2. The computer-implemented method of claim 1, wherein the OCI is uploaded to the global repository that synchronizes the OCI with a public marketplace of open container images (OCIs).

3. The computer-implemented method of claim 2, wherein the local repository is stored in a private cloud of the customer computing environment that is separate from the public marketplace.

4. The computer-implemented method of claim 1, wherein an operator function executes a job of downloading the layer to the local repository and extracting the layer while maintaining a same directory structure.

5. The computer-implemented method of claim 4, wherein the operator function is a Kubernetes™ operator and the same directory structure is a Kubernetes™ cluster directory structure.

6. The computer-implemented method of claim 1, wherein the cloning of the layer of the OCI is implemented by an inference service of the user namespace.

7. The computer-implemented method of claim 1, wherein the OCI corresponds with an Nvidia Inference Microservice (NIM) having a serving container image and the machine learning model.

8. The computer-implemented method of claim 1, further comprising:
providing a reference to a second OCI at an interface; and
in response to an interaction received via the interface, initiating the automatic download of the second OCI to the local repository of the customer computing environment.

9. The computer-implemented method of claim 1, wherein the local repository is located in a cluster data structure of a private cloud.

10. The computer-implemented method of claim 1, wherein the update to the layer is an upgrade or patch to the machine learning model.

11. A private cloud platform comprising:
a memory storing instructions; and
a processor communicatively coupled to the memory and configured to execute the instructions to:
automatically download from a global repository to a local repository of a customer computing environment, a layer of an open container image (OCI), wherein the OCI comprises a set of layers of a machine learning model;
automatically extract the machine learning model to a local cache in the customer computing environment from the layer of the OCI;
clone the layer of the OCI from the local cache to a user namespace that utilizes the machine learning model; and
in response to the layer being updated, initiate a synchronization process that automatically updates the local repository and the user namespace of the customer computing environment.

12. The private cloud platform of claim 11, wherein the OCI is uploaded to the global repository that synchronizes the OCI with a public marketplace of open container images (OCIs).

13. The private cloud platform of claim 12, wherein the local repository is stored in a private cloud of the customer computing environment that is separate from the public marketplace.

14. The private cloud platform of claim 11, wherein an operator function executes a job of downloading the layer to the local repository and extracting the layer while maintaining a same directory structure.

15. The private cloud platform of claim 14, wherein the operator function is a Kubernetes™ operator and the same directory structure is a Kubernetes™ cluster directory structure.

16. The private cloud platform of claim 11, wherein the cloning of the layer of the OCI is implemented by an inference service of the user namespace.

17. The private cloud platform of claim 11, wherein the OCI corresponds with an Nvidia Inference Microservice (NIM) having a serving container image and the machine learning model.

18. The private cloud platform of claim 11, wherein the processor is further configured to:
provide a reference to a second OCI at an interface; and
in response to an interaction received via the interface, initiate the automatic download of the second OCI to the local repository of the customer computing environment.

19. The private cloud platform of claim 11, wherein the local repository is located in a cluster data structure of a private cloud.

20. A non-transitory computer-readable storage medium storing a plurality of instructions executable by a processor, the plurality of instructions when executed by the processor cause the processor to:
automatically download from a global repository to a local repository of a customer computing environment, a layer of an open container image (OCI), wherein the OCI comprises a set of layers of a machine learning model;
automatically extract the machine learning model to a local cache in the customer computing environment from the layer of the OCI;
clone the layer of the OCI from the local cache to a user namespace that utilizes the machine learning model; and
in response to the layer being updated, initiate a synchronization process that automatically updates the local repository and the user namespace of the customer computing environment.
